(19) United States
(12) Patent Application Publication
(10) Pub. No.: US 2023/0250869 A1
(43) Pub. Date: Aug. 10, 2023

(54) FLUID CONVEYANCE DEVICE

(71) Applicant: TOYOTA JIDOSHA KABUSHIKI KAISHA, Toyota-shi (JP)

(72) Inventor: Yushi KAKUTA, Numazu-shi (JP)

(73) Assignee: TOYOTA JIDOSHA KABUSHIKI KAISHA, Toyota-shi (JP)

(21) Appl. No.: 18/102,317

(22) Filed: Jan. 27, 2023

(30) Foreign Application Priority Data
Feb. 9, 2022 (JP) 2022-018861

(51) Int. Cl. F16H 57/04

(52) U.S. Cl. CPC F16H 57/0434; F16H 57/0471; B64G 1/16

(57) ABSTRACT

A fluid conveyance device that conveys a fluid in a low gravity and high vacuum environment, includes: an endless belt member having an uneven surface on an outer peripheral side of the endless belt; a belt driving gear that meshes with the uneven surface and rotationally drives the belt member; a fluid supplying portion that supplies the fluid to a fluid supply target; and a fluid storage portion that stores the fluid. Further, the belt member captures the fluid stored in the fluid storage portion by the uneven surface and conveys the fluid to the fluid supplying portion.

### CROSS-REFERENCE TO RELATED APPLICATION(S)

The present application claims priority to and incorporates by reference the entire contents of Japanese Patent Application No. 2022-018861 filed in Japan on Feb. 9, 2022.

### BACKGROUND

The present disclosure relates to a fluid conveyance device.

A lubricating device that injects a lubricating oil pumped up by an oil pump to a meshing portion of a plurality of gears with a nozzle is disclosed in Japanese Laid-open Patent Publication No. 2010-507768.

Under a low gravity and high vacuum environment such as on a surface of the moon, it is difficult to convey fluid since a suction capacity of a pump that pumps up fluid such as lubricating oil is significantly decreased as compared with that on a surface of the earth.

There is a need for providing a fluid conveyance device capable of conveying fluid in the low gravity and high vacuum environment.

To resolve the problem and attain the object, according to an embodiment, a fluid conveyance device that conveys a fluid in a low gravity and high vacuum environment, includes: an endless belt member having an uneven surface on an outer peripheral side of the endless belt; a belt driving gear that meshes with the uneven surface and rotationally drives the belt member; a fluid supplying portion that supplies the fluid to a fluid supply target; and a fluid storage portion that stores the fluid. Further, the belt member captures the fluid stored in the fluid storage portion by the uneven surface and conveys the fluid to the fluid supplying portion.

### BRIEF DESCRIPTION OF THE DRAWINGS

FIG. 1 is a view illustrating a schematic configuration of a gearbox including a fluid conveyance device according to an embodiment;

FIG. 2 is a cross-sectional view taken along a line A-A of the gearbox illustrated in FIG. 1;

FIG. 3A is a view illustrating an example of a clearance between protrusions of a belt and an inner wall surface of a gearbox case;

FIG. 3B is a view illustrating in an arrow B view in FIG. 3A;

FIG. 4 is a view illustrating another configuration example of the gearbox according to the embodiment;

FIG. 5 is a view illustrating another configuration example of the gearbox according to the embodiment;

FIG. 6 is a view illustrating an example of a configuration of an oil supplying portion;

FIG. 7 is a view illustrating another example of a configuration of the oil supplying portion;

FIG. 8 is a view illustrating a part of a chain belt;

FIG. 9 is a flowchart illustrating an example of control performed in a case where a vibration level exceeds an allowable value, for example, during traveling on a rough road; and

FIG. 10 is a flowchart illustrating an example of control performed in a case where time during which the vibration level exceeding the allowable value is continuous, for example, during traveling on the rough road.

### DETAILED DESCRIPTION

In the following, an embodiment of a fluid conveyance device according to the present disclosure will be described. In the present embodiment, a case where the fluid conveyance device according to the present disclosure is applied to a lubricating device provided in a gearbox included in a vehicle traveling on a surface of the moon or the like in a low gravity and high vacuum environment will be described as an example. Note that the present disclosure is not limited to the present embodiment.

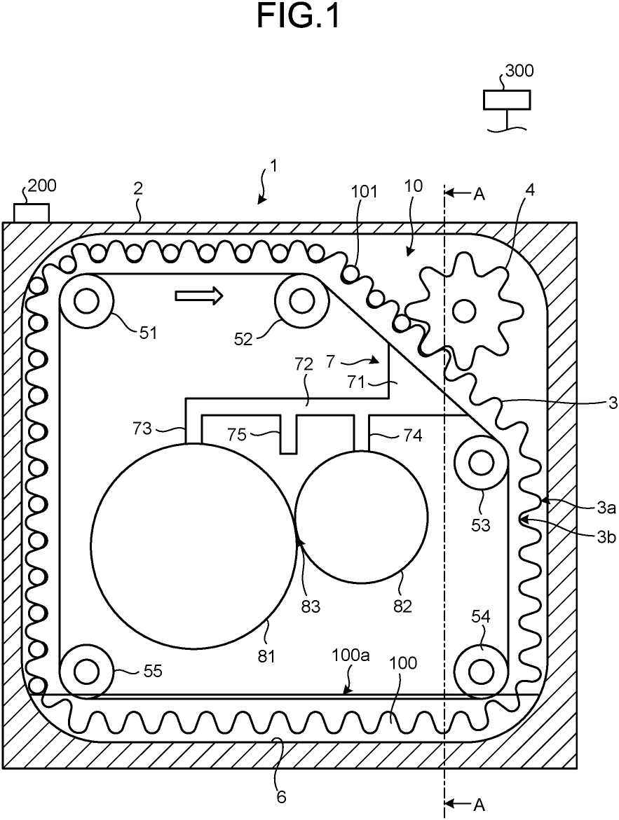

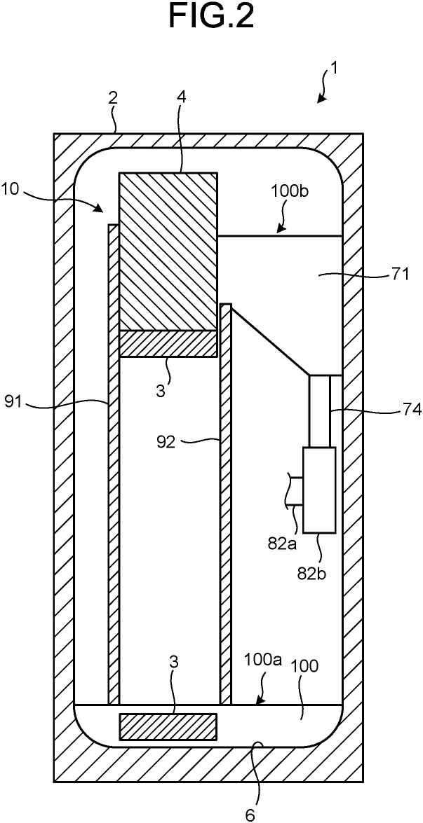

FIG. 1 is a view illustrating a schematic configuration of a gearbox 1 including a fluid conveyance device 10 according to an embodiment. FIG. 2 is a cross-sectional view taken along a line A-A of the gearbox 1 illustrated in FIG. 1.

As illustrated in FIG. 1, the gearbox 1 according to the embodiment is provided with the fluid conveyance device 10 including a belt 3, a belt driving gear 4, a plurality of belt conveyance rollers 51, 52, 53, 54, and 55, an oil pan 6, an oil supplying portion 7, a first gear 81, a second gear 82, a vibration measuring sensor 200, and the like in a gearbox case 2.

The belt 3 is, for example, an endless belt member made of resin, and is rotatably stretched around the plurality of belt conveyance rollers 51, 52, 53, 54, and 55 arranged on an inner peripheral side. A surface on the inner peripheral side of the belt 3 is a flat surface in contact with roller surfaces of the belt conveyance rollers 51, 52, 53, 54, and 55, and a surface on an outer peripheral side of the belt 3 is an uneven surface in which protrusions 3a and recesses 3b are alternately arranged in a belt rotating direction. The uneven surface of this belt 3 meshes with external teeth of the belt driving gear 4 including an external gear. For example, the belt driving gear 4 rotates counterclockwise in FIG. 1 by driving force from a dedicated driving motor (not illustrated), whereby the belt 3 rotates in one direction (clockwise direction in FIG. 1) at a low speed. Note that a power source of the belt driving gear 4 is not limited to the provision of the dedicated driving motor. For example, a power transmission mechanism that transmits driving force by belt transmission, gear transmission, or the like from a rotation shaft of the first gear 81 or a rotation shaft of the second gear 82 to the belt driving gear may be provided.

The vibration measuring sensor 200 that measures a vibration level of the gearbox 1 is provided on an upper portion of the gearbox case 2. The oil pan 6 that is a fluid storage portion that stores a lubricating oil 100 is provided in a lower portion of the gearbox case 2. For example, as illustrated in FIG. 1, an amount of the lubricating oil 100 accumulated in the oil pan 6 is set, for example, to an amount with which the belt 3 sinks in such a manner that the surface on the inner peripheral side of the belt 3 between the two belt conveyance rollers 54 and 55 arranged in the lower portion of the gearbox case 2 is placed slightly below an oil level 100a of the lubricating oil 100. Since the oil pan 6 can capture the lubricating oil 100 when the lubricating oil 100 exists to such an extent that the uneven surface of the belt 3 is immersed in the oil, a deep oil pan such as a suction type oil pump (such as inscribed gear type or circumscribed gear type) is unnecessary. In addition, since the gearbox 1 is often arranged near a wheel, a reduction in a depth dimension of the oil pan 6 enables to raise a minimum ground clearance of the vehicle, and traveling performance of the vehicle can be improved.

In the gearbox 1 according to the embodiment, the lubricating oil 100 accumulated in the oil pan 6 is captured by the uneven surface of the belt 3 by the rotation of the belt 3. Here, since the gravity is lower on the surface of the moon than on the earth, the lubricating oil 100 captured on the uneven surface of the belt 3 becomes a spherical oil clot 101 by surface tension and is fitted into the recesses 3b in the uneven surface of the belt 3. Then, along with the rotation of the belt 3, the lubricating oil 100 captured by the uneven surface of the belt 3 is conveyed from the oil pan 6 to the upper portion of the gearbox 1.

In the gearbox 1 according to the embodiment, a wall surface of the gearbox case 2 is provided in at least a part between the oil pan 6 and the oil supplying portion 7 in a rotation direction of the belt 3 in such a manner as to face the protrusions 3a of the uneven surface with a predetermined clearance (predetermined interval) in a thickness direction of the belt 3. Specifically, as illustrated in FIG. 1, the uneven surface of the belt 3 between the two belt conveyance rollers 51 and 55 respectively arranged in the upper portion and the lower portion of the gearbox case 2 is arranged along the inner surface of the gearbox case 2 with a predetermined clearance provided therebetween, whereby the oil clot 101 is prevented from falling off from the recesses 3b in the uneven surface of the belt 3. In addition, a conveyance property of the lubricating oil 100 (oil clot 101) by the uneven surface of the belt 3 can be improved by execution of oil repellent treatment on the surface, which includes at least the uneven surface of the belt 3, to utilize an effect of wettability of the lubricating oil 100 (oil clot 101) with respect to the belt 3.

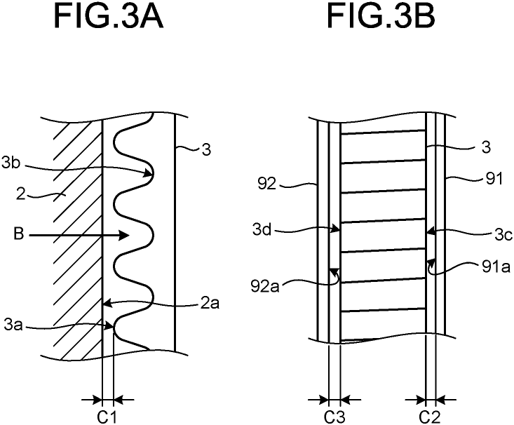

As in the gearbox 1 according to the embodiment, in a case where the oil clot 101 is fitted into the recesses 3b in the uneven surface of the belt 3 and conveyed, a loss due to leakage of the lubricating oil 100 from a clearance C1 between an inner wall surface 2a of the gearbox case 2 and the protrusions 3a on the uneven surface of the belt 3 in a manner illustrated in FIG. 3A, or clearances C2 and C3 between wall surfaces 91a and 92a of a pair of side covers 91 and 92, which are arranged in such a manner as to sandwich the belt 3 in a width direction of the belt 3, and side surfaces 3c and 3d of the belt 3 in a manner illustrated in FIG. 3B is small. Thus, the large clearances C1, C2, and C3 can be secured, and the clearances C1, C2, and C3 can be made larger as the gravity is lower, whereby friction of when the belt 3 is rotated and the oil clot 101 is conveyed can be reduced.

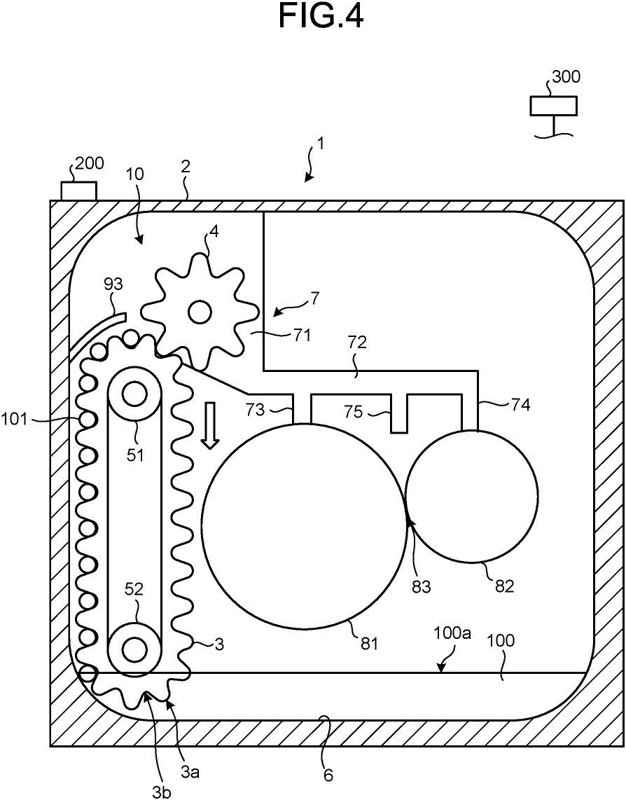

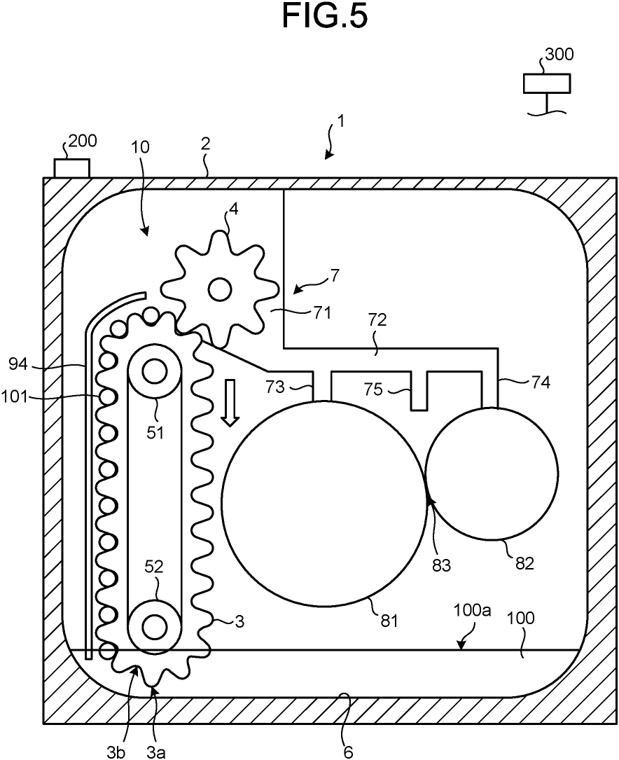

Note that in the gearbox 1 according to the embodiment, as an oil clot fall prevention fence to prevent the oil clot 101 from falling from the recesses 3b in the uneven surface of the belt 3, a belt top cover 93 arranged in such a manner as to protrude from an inner wall surface of the gearbox case 2 as illustrated in FIG. 4, or a belt top cover 94 arranged in such a manner that a part thereof is arranged along the inner wall surface of the gearbox case 2 with a predetermined clearance from the inner wall surface as illustrated in FIG. 5 may be provided. Then, as the gearbox 1 according to the embodiment, a configuration in which the belt 3 is arranged at corners of the gearbox case 2 in a manner of being rotatable by the two belt conveyance rollers 51 and 52, which are respectively arranged in the upper portion and the lower portion of the gearbox 1, in such a manner that wall surfaces of the belt top covers 93 and 94 and the protrusions 3a of the uneven surface of the belt 3 face each other with a predetermined clearance in the thickness direction of the belt 3 may be employed.

Along with the rotation of the belt 3, the belt 3 that captures the oil clot 101 on the uneven surface moves along the inner wall surface of the gearbox case 2 in the vertical direction, and the oil clot 101 conveyed to the upper portion of the gearbox 1 is conveyed to a position, at which the uneven surface of the belt 3 and the belt driving gear 4 mesh with each other, between the two belt conveyance rollers 52 and 53 respectively arranged in the upper portion and a middle portion of the gearbox 1. Then, by being pressed by the belt driving gear 4 at the meshing position, the oil clot 101 is pushed out from the recesses 3b in the uneven surface of the belt 3 to an oil reservoir 71 of the oil supplying portion 7 that is a fluid supplying portion that supplies, to a fluid supply target, the lubricating oil that is the fluid. Note that a reference sign 100b illustrated in FIG. 2 indicates an oil level of the lubricating oil 100 in the oil reservoir 71. A position of an oil level 100b in the oil reservoir 71 is displaced by an amount of the lubricating oil 100 conveyed to the oil reservoir 71 by the belt 3.

The lubricating oil 100 in the oil reservoir 71 falls into a lubricating pipe 72, passes through the lubricating pipe 72, and is supplied to each of a first supplying pipe 73 to supply the lubricating oil 100 to a bearing portion of the first gear 81, a second supplying pipe 74 to supply the lubricating oil 100 to a bearing portion of the second gear 82, and a third supplying pipe 75 to supply the lubricating oil 100 to a meshing portion 83 between the first gear 81 and the second gear 82. The lubricating oil 100 supplied to the first supplying pipe 73 is supplied from a discharge port provided in a lower portion of the first supplying pipe 73 to a bearing portion that rotatably supports a rotation shaft of the first gear 81. The lubricating oil 100 supplied to the second supplying pipe 74 is supplied from a discharge port provided in a lower portion of the second supplying pipe 74 to a bearing portion 82b that rotatably supports a rotation shaft 82a of the second gear 82, as illustrated in FIG. 2. The lubricating oil 100 supplied to the third supplying pipe 75 is supplied from a discharge port provided in a lower portion of the third supplying pipe 75 to the meshing portion 83 between the first gear 81 and the second gear 82.

The lubricating oil 100 accumulated in the oil reservoir 71 may be supplied respectively from the supplying pipes 73, 74, and 75 to the supply destinations without an adjustment of a supplied amount of the lubricating oil 100 from the lubricating pipe 72. When the lubricating oil 100 is in the extent of being attached to the surface, a sufficient sliding portion protection function works on a tooth surface and the bearing portion of each of the first gear 81 and the second gear 82. Thus, it is sufficient that a small amount of the lubricating oil 100 is supplied to the bearing portion of the first gear 81, the bearing portion of the second gear 82, and the meshing portion 83 between the first gear 81 and the second gear 82. Thus, the amount of the lubricating oil 100 conveyed by the belt 3 to the oil reservoir 71 and the oil pan 6 by a rotation speed of the belt 3 is adjusted by the rotation speed of the belt 3. At that time, the low-speed rotation is sufficient for the belt 3.

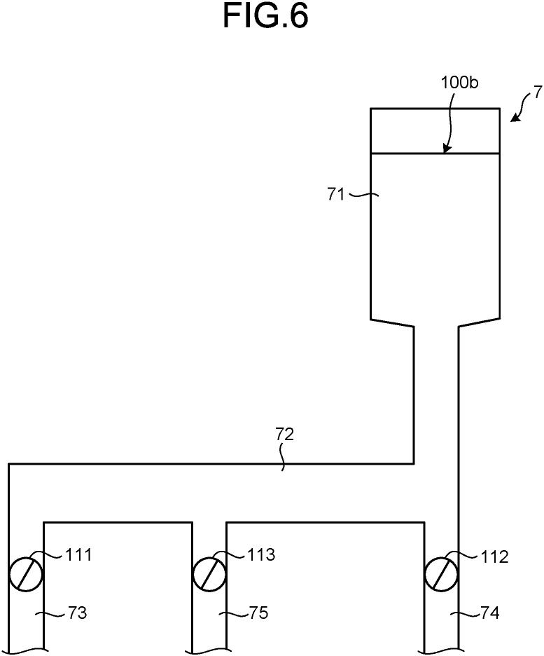

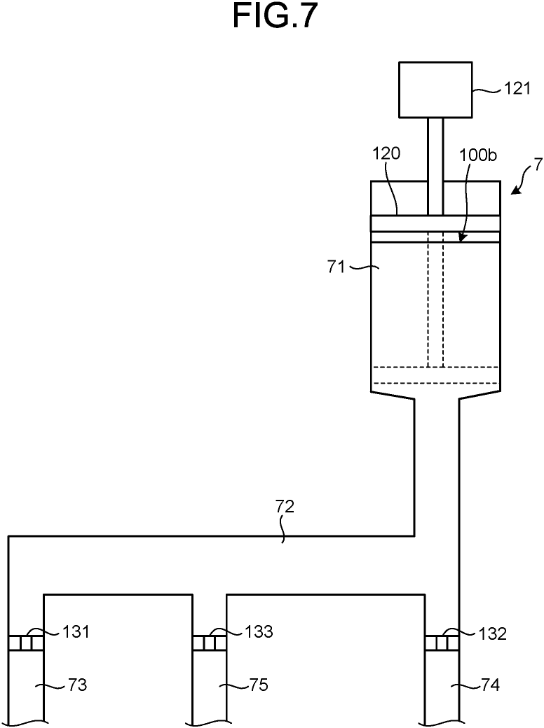

On the other hand, for example, as illustrated in FIG. 6, regulation valves 111, 112, and 113 may be provided respectively in the middle of supplying pipes 73, 74, and 75 as oil amount regulating units to regulate the amount of supplied oil. As a result, by adjusting an opening degree of each of the regulation valves 111, 112, and 113, it is possible to supply a necessary amount of a lubricating oil 100 to a necessary portion. In addition, as illustrated in FIG. 7, in a case where a mechanism that pushes out lubricating oil 100, which is accumulated in an oil reservoir 71, by a piston 120 that can be displaced by a solenoid 121 is provided, it is possible to supply an accurate amount of oil to a lubricating pipe 72 as compared with a case where the lubricating oil 100 naturally falls from the oil reservoir 71. Orifices 131, 132, and 133 may be respectively provided in the middle of supplying pipes 73, 74, and 75 as oil amount regulating units to regulate the amount of supplied oil, and an oil amount distribution to each lubrication portion may be controlled by regulation of a throttle of each of the orifices 131, 132, and 133. Note that the opening degree of each of the regulation valves 111, 112, and 113 illustrated in FIG. 6, the throttle of each of the orifices 131, 132, and 133 illustrated in FIG. 7, and the like may be acquired in advance by, for example, an experiment or the like.

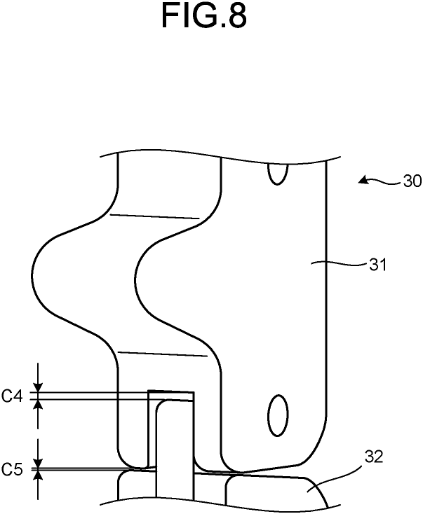

Here, since timing belts generally used in an automobile field have high durability, those made of a fluorine-based rubber or the like adapted to a high vacuum environment can be sufficiently used as a material of the belt 3. In addition, a metal chain belt 30 coupled by links 31 and 32 having uneven surfaces as illustrated in FIG. 8 can also be used instead of the belt 3. In a case where the chain belt 30 is used instead of the belt 3, for example, there is a minute clearance (clearances C4 and C5 in FIG. 8) in a coupling portion between the link 31 and the link 32. However, since surface tension of lubricating oil 100 is applied greatly on a low-gravity surface of the moon, the lubricating oil 100 that becomes an oil clot 101 is less likely to leak from the clearance. Thus, the chain belt 30 made of metal having higher durability and excellent vacuum compatibility can also be used similarly to the belt 3.

In the gearbox 1 according to the embodiment, in a case where a dedicated driving motor is used as a power source that drives the belt driving gear 4, for example, a vibration level of the gearbox 1 may be measured with the vibration measuring sensor 200 provided in the gearbox 1 by a control device 300 provided in a vehicle, and the belt driving may be controlled according to the measured vibration level.

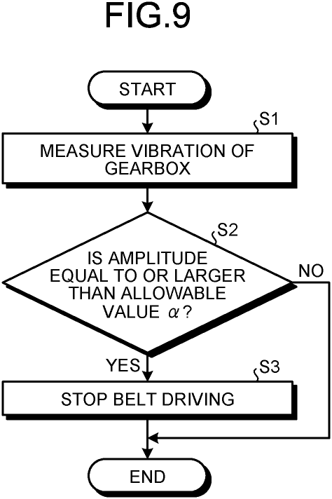

FIG. 9 is a flowchart illustrating an example of control performed in a case where a vibration level exceeds an allowable value during traveling on a rough road or the like.

First, the control device 300 measures a vibration of the gearbox 1 by the vibration measuring sensor 200 (Step S1). Then, the control device 300 determines whether amplitude of the vibration is equal to or larger than an allowable value α (Step S2). In a case of determining that the amplitude of the vibration is smaller than the allowable value α (No in Step S2), the control device 300 ends the series of control. On the other hand, in a case of determining that the amplitude of the vibration is equal to or larger than the allowable value α (Yes in Step S2), the control device 300 stops the belt driving (Step S3). Then, the control device 300 ends the series of control.

Since the sufficient sliding portion protection function works on the tooth surfaces and the bearing portions of the first gear 81 and the second gear 82 when the lubricating oil 100 is in the extent of being attached to the surfaces, even when the supply of the lubricating oil 100 is temporarily stopped, a failure is not immediately caused. Thus, for example, in a case where a violent vibration is detected during traveling on a rough road on the basis of a result of the measurement by the vibration measuring sensor 200, the belt 3 is protected by performance of control to temporarily stop the belt driving. As a result, weight of the belt 3 can be reduced since strength of the belt 3 can be reduced.

In addition, in a case where such rough road traveling continues successively, for example, break time for stopping the vehicle may be periodically provided and control to supply the lubricating oil 100 by the belt driving may be performed during the break time.

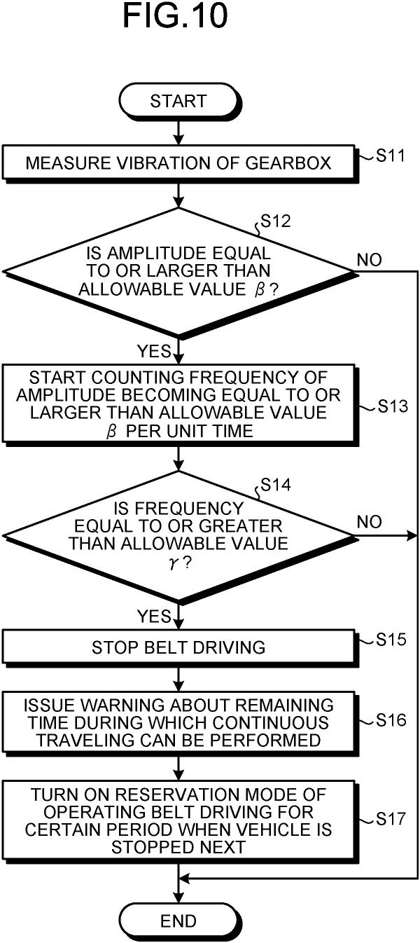

FIG. 10 is a flowchart illustrating an example of control performed in a case where a vibration level exceeds an allowable value β successively during traveling on a rough road or the like.

First, the control device 300 measures a vibration of the gearbox 1 by the vibration measuring sensor 200 (Step S11). Then, the control device 300 determines whether amplitude of the vibration is equal to or larger than the allowable value β (Step S12). In a case of determining that the amplitude of the vibration is smaller than the allowable value β (No in Step S12), the control device 300 ends the series of control. On the other hand, in a case of determining that the amplitude of the vibration is equal to or larger than the allowable value β (Yes in Step S12), the control device 300 starts counting a frequency of the amplitude becoming equal to or larger than the allowable value β per unit time (Step S13). Then, the control device 300 determines whether the frequency is equal to or greater than an allowable value γ (Step S14). In a case of determining that the frequency is less than the allowable value γ (No in Step S14), the control device 300 ends the series of control. On the other hand, in a case of determining that the frequency is equal to or greater than the allowable value γ (Yes in Step S14), the control device 300 stops the belt driving (Step S15). Then, the control device 300 issues a warning about remaining time during which continuous traveling can be performed (Step S16). Then, the control device 300 turns on a reservation mode of operating the belt driving for a certain period when the vehicle is stopped next (Step S17). Then, the control device 300 ends the series of control.

As a result, in a case where the rough road traveling continues successively, break time for stopping the vehicle is periodically provided, and the lubricating oil 100 is supplied to the bearing portion of the first gear 81, the bearing portion of the second gear 82, and the meshing portion 83 between the first gear 81 and the second gear 82 by the belt driving during the break time, whereby the sliding portion protection function can be further maintained.

The fluid conveyance device 10 included in the gearbox 1 according to the embodiment is a means effective for a fluid having high viscosity, such as the lubricating oil 100 (oil) and is a means specifically effective in an environment in which an atmospheric gas such as air is lean. In addition, the fluid conveyance device 10 included in the gearbox 1 according to the embodiment is effective in a low gravity and high vacuum environment in which suction performance of the oil pump is significantly deteriorated. Furthermore, in addition to the use on the surface of the moon, the fluid conveyance device 10 included in the gearbox 1 according to the embodiment can be also used for a use on a surface of another planet or satellite such as Mars, for a lubrication system of a mobility device in the sky, the mobility device flying at a high altitude where there is almost no air and being, for example, a flying object for space tourism in which an increase in the number of users is expected in the future, and the like. In addition, the fluid conveyance device 10 according to the embodiment can convey water as a fluid under a low gravity (microgravity) and high vacuum environment by minimization of each clearance between the uneven surface of the belt 3 and the wall surface. In addition, the fluid conveyance device 10 according to the embodiment can be also applied to, for example, conveyance of sewage in a facility provided in space, on the surface of the moon, or the like.

The fluid conveyance device according to the present disclosure has an effect that it is possible to convey a fluid in the low gravity and high vacuum environment.

According to an embodiment, the fluid in a form of a spherical clot in the low gravity and high vacuum environment can be captured by the uneven surface and conveyed from the fluid storage portion to the fluid supplying portion.

According to an embodiment, both the driving of the belt member and the supplying of the fluid to the fluid supplying portion can be performed by the belt driving gear.

According to an embodiment, it is possible to control a fluid from falling off from recesses of the uneven surface during the conveyance of the fluid by the belt member.

According to an embodiment, a lubricating oil can be supplied to a sliding portion in the gearbox.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A fluid conveyance device that conveys a fluid in a low gravity and high vacuum environment, the fluid conveyance device comprising:
an endless belt member having an uneven surface on an outer peripheral side of the endless belt;
a belt driving gear that meshes with the uneven surface and rotationally drives the belt member;
a fluid supplying portion that supplies the fluid to a fluid supply target; and
a fluid storage portion that stores the fluid, wherein
the belt member is configured to capture the fluid stored in the fluid storage portion by the uneven surface and convey the fluid to the fluid supplying portion.

2. The fluid conveyance device according to claim 1, wherein the fluid is pushed out from the uneven surface and flows into the fluid supplying portion at a position where the uneven surface and the belt driving gear mesh with each other.

3. The fluid conveyance device according to claim 1, wherein a wall surface facing protrusions of the uneven surface with a predetermined interval in a thickness direction of the belt member is provided in at least a part between the fluid storage portion and the fluid supplying portion in a rotation direction of the belt member.

4. The fluid conveyance device according to claim 1, wherein the fluid is a lubricating oil, and
the fluid conveyance device is provided in a gearbox provided in a vehicle.
